(19) United States
(12) Patent Application Publication
(10) Pub. No.: US 2026/0215612 A1
(43) Pub. Date: Jul. 30, 2026

(54) INDEXING TRAY FOR A BEVERAGE MACHINE

(71) Applicant: Keurig Green Mountain, Inc., Burlington, MA (US)

(72) Inventors: Janelle Marie Gregory, Chicago, IL (US); Blair Mikkelsen, Chicago, IL (US); Nicholas John Raleigh, Saint Joseph, MI (US); Jonathan Meehan, Saint Joseph, MI (US)

(73) Assignee: Keurig Green Mountain, Inc., Burlington, MA (US)

(21) Appl. No.: 19/158,242

(22) PCT Filed: Feb. 21, 2024
(86) PCT No.: PCT/US2024/016670

§ 371 Date: Aug. 20, 2025

Related U.S. Application Data
(60) Provisional application No. 63/486,450, filed on Feb. 22, 2023.

(51) Int. Cl. A47J 31/36; B65D 85/804

(52) U.S. Cl. CPC A47J 31/3633; A47J 31/3642; B65D 85/8046

(57) ABSTRACT

Aspects described herein relate to beverage machines and methods of brewing beverages therein. According to some embodiments, a beverage machine includes an indexing tray. The indexing tray may include a plurality of pod receptacles which may be moved to and from a brewing position. The indexing tray may move spent beverage material out of the brewing position. A user may remove the indexing tray from the beverage machine to remove spent beverage material from the beverage machine. According to other embodiments, the indexing tray may receive a cassette of beverage ingredients and position a beverage pod into position for brewing. Spent beverage material may be retained within the cassette. The user may remove and dispose of the cassette to remove spent beverage material from the beverage machine.

### CROSS REFERENCE TO RELATED APPLICATION

This application claims the benefit of U.S. Provisional Application No. 63/486,450, filed Feb. 22, 2023, which is hereby incorporated by reference in its entirety.

### FIELD

The present disclosure relates to beverage making machines, such as coffee brewers that use a liquid to form a coffee beverage.

### BACKGROUND

Beverage machines are widely used to make beverages using capsules that contain ingredients, such as coffee grounds, tea leaves, and/or other soluble and/or insoluble ingredients. Such beverage machines can often be used with capsules containing a wide variety of different ingredients so as to make different beverages, such as coffee, tea, hot chocolate, flavored still drinks, flavored carbonated drinks, and so on.

### SUMMARY

According to some aspects a beverage machine comprises a brew chamber lid and a tray including a first portion and a second portion. The tray is moveable relative to the brew chamber lid. The tray is moveable to position the first portion of the tray into a brewing position to cooperate with the brew chamber lid to brew a first beverage from a first beverage pod. The tray is moveable to position a second portion of the tray into the brewing position to cooperate with the brew chamber lid to brew a second beverage from a second beverage pod.

According to other aspects, a method of forming a beverage comprises moving a tray to position a first beverage pod into position for brewing, brewing a first beverage with the first beverage pod, moving the tray to position a second beverage pod into position for brewing and to move spent beverage material of the first beverage pod out of position for brewing.

According to other aspects, a cassette of beverage pods comprises a cassette housing configured to be removably received within a beverage machine. The cassette includes a plurality of pod receptacles each containing at least one beverage pod.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a front view of a beverage machine according to some embodiments;

FIG. 2 is a front view of the beverage machine of FIG. 1 with a portion removed to show internal components;

FIG. 3 is a perspective view of an indexing tray for a beverage machine;

FIG. 4 is a top view of the indexing tray of the embodiment of FIG. 3;

FIG. 5A is a section view of the indexing tray of FIG. 3 within a portion of a beverage machine according to some embodiments;

FIG. 5B is a perspective view of the indexing tray and beverage machine of FIG. 5A;

FIG. 6 is another embodiment of an indexing tray for a beverage machine;

FIG. 7 is another embodiment of an indexing tray for a beverage machine;

FIG. 8 is a view of one embodiment of a beverage pod;

FIG. 9 is a view of an embodiment of an indexing tray for a beverage machine and a cassette of beverage ingredients;

FIG. 10 is a schematic diagram of components of a beverage machine in an illustrative embodiment; and

FIG. 11 is a diagram for a method of forming a beverage.

### DETAILED DESCRIPTION

It should be understood that aspects of the invention are described herein with reference to the figures, which show illustrative embodiments. The illustrative embodiments described herein are not necessarily intended to show all embodiments in accordance with the invention, but rather are used to describe a few illustrative embodiments. Thus, aspects of the invention are not intended to be construed narrowly in view of the illustrative embodiments. In addition, it should be understood that aspects of the invention may be used alone or in any suitable combination with other aspects of the invention.

A beverage machine may be used to form a beverage by combining a beverage precursor liquid with a beverage ingredient. Single serving or small batch beverage machines are popular in the market. These beverage machines allow a user to prepare a small quantity of a beverage such as a single serving or a small batch of beverage. Multiple users can use the same machine to prepare different beverages, such as individual servings of different beverage types or beverage flavors quickly and without wasting unconsumed beverage.

A single serving or small batch beverage machine may be used with a beverage pod to form a beverage such as tea, coffee, espresso, cocoa or other infusion type beverages. The beverage pod may include beverage ingredients such as suitably prepared coffee beans, tea leaves, etc. The beverage machine may form such beverages using a beverage precursor liquid, such as water, that may be combined with the beverage ingredients of the beverage pod under suitable conditions to form the beverage.

Conventional beverage pods are typically individually packaged servings of beverage ingredients, such as suitably ground coffee, to be combined with liquid and brewed. These individual packages of beverage ingredients may then be disposed after the beverage has been prepared.

The inventors have recognized and appreciated improvements in beverage machines, beverage ingredients packaging and methods of preparing a beverage. These improvements may reduce beverage ingredients packaging and/or waste resulting from the preparation of a beverage. Beverage ingredients may be portioned for use within a beverage machine without separate disposable packaging for each portion according to some embodiments disclosed herein.

In some embodiments, the beverage machine may be used with package-less beverage pods. The package-less beverage pod may be able to hold its own shape, and thus may not require individual packaging to prevent dispersing of the beverage ingredients prior to use in forming a beverage. Such beverage pods may, for example, be in the form of a compacted tablet or a capsule (which may or may not be made of compacted materials). The beverage ingredients may held together without a separate, removable vessel. In some embodiments, the beverage ingredients of the package-less beverage pod have been compacted. In some embodiments, the package-less beverage pod may be bound together with a food-grade binder or with another beverage ingredient that promotes formation of the beverage tablet into a cohesive structure. Some package-less beverage pods may be formed through processing alone, such as by pressing, heating, or drying into the desired form.

In some embodiments, the package-less beverage pod may include a shell, such as a coating, disposed along the outer surface at the periphery of the pod. In some embodiments, the shell may bind the beverage ingredients within the interior of the pod. The beverage ingredients within the pod may be loose, such as loose ground coffee, or compacted. The shell may be a food grade binder, an alginate, edible, soluble, or any other suitable material. In some embodiments, the shell may serve as a barrier to reduce infiltration of oxygen and/or moisture such as to maintain freshness of the beverage ingredients. Material of the package-less beverage pod, including a shell of the pod if one is present, may directly contact some portion of the beverage machine, such as the brew chamber, before brewing the beverage, without intervening packaging in-between.

The package-less beverage pod may be configured to break into pieces during brewing or it may be configured to remain intact during brewing. The package-less beverage pod may be configured to at least partially or completely dissolve. In some embodiments, the package-less beverage pod may contain roasted coffee grounds (e.g. that remain behind after forming a beverage), soluble coffee, soluble materials, binders or other materials, and any combination of the above. The package-less beverage pod may be any suitable shape, such as a cylinder, a sphere, an ellipsoid, an elliptical prism, a teardrop shape, a frustrum of a cone, a cone or other shape.

In other embodiments, however, the beverage pod may be an individually packaged serving of beverage ingredients. The individual package of beverage ingredients may be removed from the beverage making machine and discarded after the beverage has been prepared. In some embodiments, at least a portion of or the entire packaging may be made of an edible, soluble, biodegradable, recyclable and/or compostable (e.g. home compostable and/or industrially compostable) material, or any combination thereof.

A beverage machine may be capable of forming a variety of single-serving beverages. Each single-serving beverage may fully utilize the beverage ingredients of a single beverage pod. A plurality of beverages may be formed from a corresponding plurality of beverage pods. After a beverage is formed, such as by brewing the beverage, the beverage material becomes spent beverage material and the beverage pod becomes a spent beverage pod. As an example, spent beverage material may be spent coffee grounds. According to some embodiments, the spent beverage material may remain within the beverage pod contained by the shell. Physical properties of the shell may change during brewing, for instance the shell may become softer and/or more elastic. In other embodiments, a beverage pod, such as a beverage pod tablet, may break during the brewing process resulting in loose spent beverage material. The spent beverage material and shell may be biodegradable. After brewing a first beverage, spent beverage material such as a spent first beverage pod may need to be removed before a second beverage pod may be moved into a brewing position to brew a second beverage. It may be desirable for a beverage machine to have the capability of removing spent beverage material from the brewing position and containing the spent beverage material so as to assist a user in removing and disposing of the spent beverage material.

According to some embodiments, an indexing tray may be provided. The indexing tray may move between different positions relative to a brew chamber lid, for the purpose of moving beverage pods to a brewing position relative to the brew chamber lid and moving spent beverage materials away from the brewing position. The indexing tray or a portion of the indexing tray may be removable from the beverage machine to assist in the removal and disposal of spent beverage material.

Fluid, including the precursor liquid, may be applied to a beverage pod from the brew chamber lid. A user may insert a beverage pod by opening the brew chamber lid, however other embodiments are contemplated where beverage pods may be loaded without the need for a user to manually open the brew chamber lid, which may not be accessible or visible to the user in some embodiments. A brew chamber lid may open in any direction such as vertically, horizontally or at any angle to a vertical or horizontal plane. Likewise, the flow of fluid into, through, or from the brew chamber lid may be in any direction or combination of directions.

In some embodiments, the indexing tray may include a plurality of pod receptacles. The indexing tray may move, such as by rotation, to bring a pod receptacle containing a fresh beverage pod into brewing position and to move the pod receptacle containing spent beverage material out of brewing position after brewing. The indexing tray may form a disc with pod receptacles spaced at an angular displacement around a central pivot axis. The indexing tray may continue to bring fresh beverage pods into the brewing position to brew successive beverages until all pod receptacles of the indexing tray are filled with spent beverage material. The indexing tray may be removed from the beverage machine, emptied, and returned to the beverage machine, for instance so that the user may avoid handling spent beverage material such as coffee grounds.

According to another embodiment, the indexing tray may receive a cassette of beverage material. The cassette of beverage material may include a plurality of beverage pods disposed in an equivalent plurality of pod receptacles spaced in the cassette. The indexing tray may position the cassette so as to move a fresh beverage pod into brewing position, brew the beverage with the beverage pod in the cassette, and advance to the next pod receptacle in the cassette to brew the next beverage. The spent beverage material may remain within the cassette. The entire cassette may be removed from the beverage machine and disposed when the supply of fresh beverage pods within the cassette has been exhausted. During brewing, the pod receptacle may cooperate with the brew chamber lid to brew the beverage. The cassette may include an identifier which may be used by the beverage machine to set brewing parameters.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

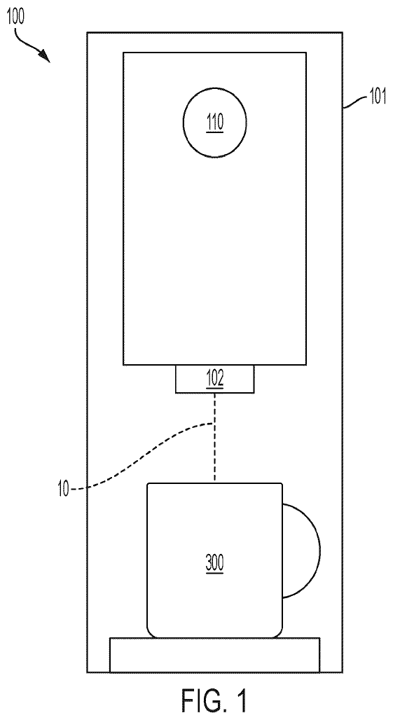

FIG. 1 depicts a beverage machine 100 according to some embodiments. The beverage machine 100 includes the beverage machine housing 101, a user interface 110, and a brewing head 102 protruding from the beverage machine housing. The beverage machine is illustrated in the process of brewing a beverage 10 (shown as a stream of beverage), emanating from the brewing head 102 and directed into a cup 300 (the cup may not part of the beverage machine). The beverage machine 100 and a beverage pod (not visible) may form a beverage forming arrangement.

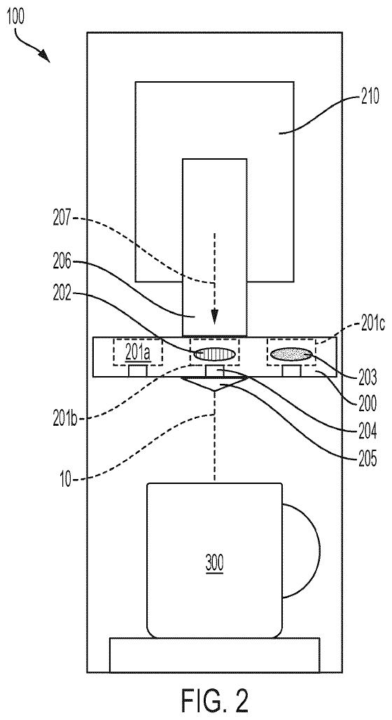

FIG. 2 depicts beverage machine 100 of the embodiment of FIG. 1 with a portion of the beverage machine housing removed to expose a portion of the mechanism of the beverage machine. An indexing tray 200 includes pod receptacles 201a-201c (three are visible in FIG. 1). In this embodiment, the pod receptacles may cooperate with a brew chamber lid to form a beverage. Pod receptacle 201b is illustrated in the brewing position below and sealed by the brew chamber lid 206. The pod receptacle 201b is undergoing the brewing process as illustrated, brewing beverage 10 from a beverage pod 202. A spent beverage pod 203 is in pod receptacle 201c and was used in a previous brewing process. Pod receptacle 201a is illustrated without a beverage pod. A beverage precursor fluid 207 is passed from a source 213 into the pod receptacle 201b from the brew chamber lid 206. The beverage precursor fluid may be liquid water in some embodiments, but may be, alternatively or in addition, other fluids such as milk, air, or steam. In some embodiments, each of the pod receptacles may include a passage 204 such that beverage flowing out of the pod receptacles may exit through a passage 204.

In some embodiments, a permeable barrier may be disposed in the pod receptacle, such as in the passage 204. The permeable barrier may be configured to permit flow of liquid through the barrier but restrict passage of solids through the barrier. As such, the permeable barrier may permit an outflow flow of brewed beverage from each pod receptacle while restricting passage of solid beverage ingredients from each pod receptacle. The permeable barrier may be a filter, a screen such as a mesh screen, a plurality of holes, a plurality of tubes or other suitable permeable barrier that may allow the passage of the beverage but may restrict passage of solid beverage materials such as may be found in the beverage pod or may escape from the beverage pod should the beverage pod rupture. The beverage machine may include an outlet 205 through which the beverage 10 is dispensed into a cup 300.

The beverage precursor fluid 207 may be supplied from source 213 and may vary according to the beverage being prepared and the selection of the user. Some ingredients may be present to froth the beverage or for similar purposes.

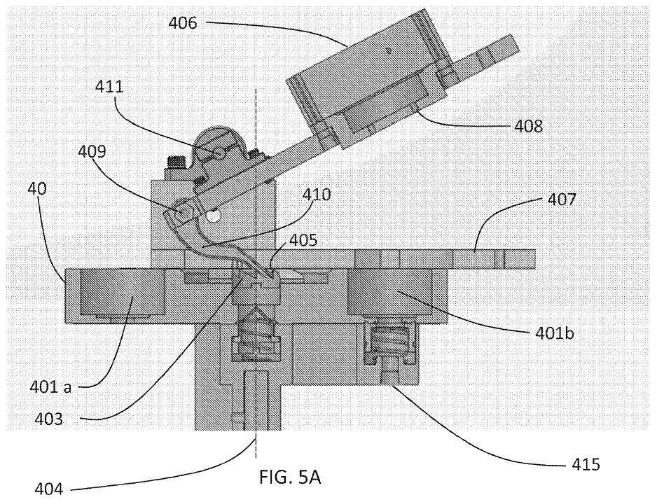

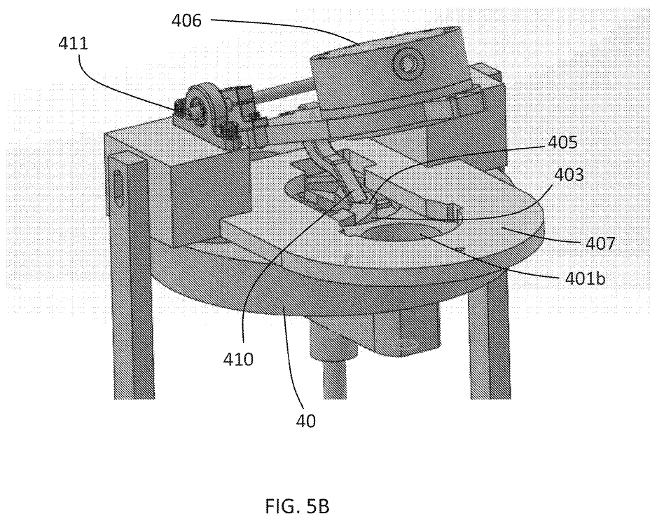

At the conclusion of the illustrated brewing process, the beverage pod 202 will be a spent pod of beverage material and may be moved out of the brewing position (where the brewing position may be directly under the brew chamber lid 206 as illustrated in FIG. 2). The brew chamber lid may not be visible to the user in all embodiments and it may be operated automatically by the beverage machine. In other embodiments, a user may open the brew chamber lid either directly or by actuating a lever, knob, or other control on the beverage machine. In some embodiments, a user may insert a fresh pod of beverage material into a pod receptacle of the tray when the brew chamber lid is open (e.g. see FIGS. 5A and 5B). The pod of beverage material may also be inserted by the beverage machine or by a user through an opening provided for that purpose. The beverage pod may be inserted into a pod receptacle in the indexing tray 200, such as pod receptacle 201a, before the pod receptacle is moved into the brewing position.

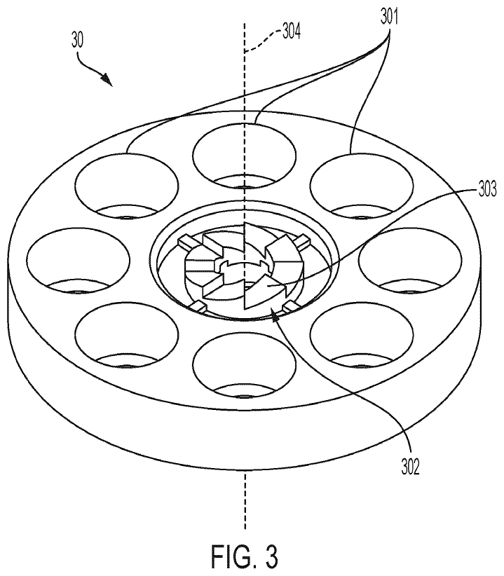

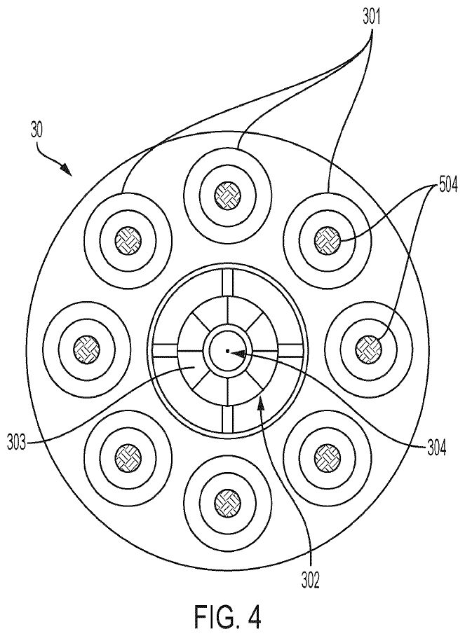

FIGS. 3 and 4 illustrate an indexing tray for a beverage machine according to some embodiments. Indexing tray 30 includes eight pod receptacles 301 that may also be brew chambers in the illustrated embodiment. The circular tray may rotate about an axis of rotation 304 of the indexing tray 30. In some embodiments, the tray may include a crown wheel 302 including ratchet teeth 303. The crown wheel may interact with an advancing mechanism in a beverage machine to move pod receptacles in and out of a brewing position as discussed in more detail below.

As shown in FIG. 4, in some embodiments, a permeable barrier 504 may be located within each pod receptacle. The permeable barrier 504 is disposed in the pod receptacle and configured to permit an outflow of brewed beverage from each pod receptacle and configured to restrict passage of solid beverage ingredients from each pod receptacle. The permeable barrier 504 may be a plurality of holes, a mesh screen, or other arrangement. The permeable barrier may behave as a filter. In some embodiments, the permeable barrier may include a plurality of small tubes or tubular projections which may extent partially into the pod receptacle/brew chamber. The projections may interact with the beverage pod, such as to puncture or pierce into the beverage pod.

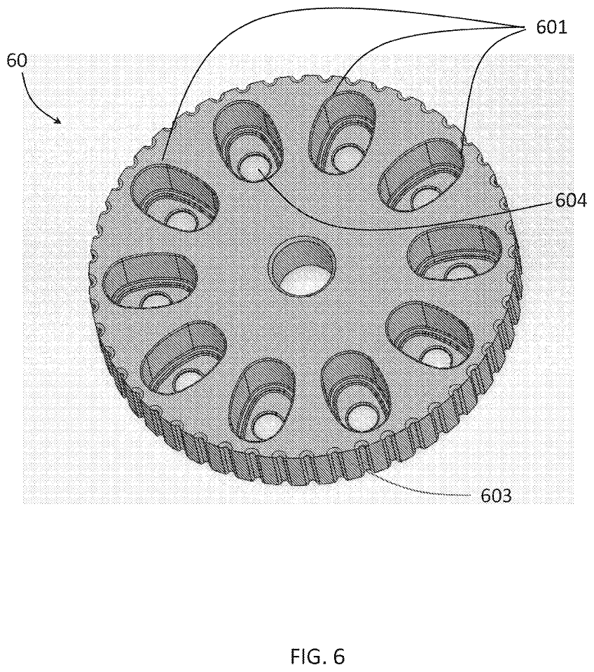

In the illustrated embodiment of FIGS. 3-5B, the indexing tray may be advanced by a ratchet and pawl mechanism, however other methods of advancing and indexing the tray are contemplated. In some embodiments, the tray may be positioned by rotating the tray about a central pivot axis with teeth, such as gear teeth, disposed on or near an outer circumference (see FIG. 6). Teeth may be external or internal teeth and may have any suitable tooth profile. Such an indexing tray may be driven by a suitable cog or pinion in the beverage machine. The motive power may come from a motor or from an interaction between a user and the beverage machine, such as by actuating a lever etc. In other embodiments, the indexing tray may be moved by a friction wheel driving on a surface of the tray or by coupling to a rotating shaft within the beverage machine. The rotating shaft may be driven by an electric motor.

In the illustrative embodiment of FIGS. 3-4, the indexing tray includes eight pod receptacles, however embodiments including more and fewer pod receptacles are also contemplated and this disclosure is not to be so limited. According to some embodiments, an indexing tray may have more than twelve pod receptacles, between three and twelve pod receptacles, between six and twelve pod receptacles, three pod receptacles, four pod receptacles, five pod receptacles, six pod receptacles, seven pod receptacles, eight pod receptacles, nine pod receptacles, ten pod receptacles, eleven pod receptacles, twelve pod receptacles or any other suitable number of pod receptacles.

The indexing tray may include at least a first portion and a second portion, where each portion includes a pod receptacle configured to receive and hold a beverage pod. The tray may be moved from a first position to a second position (e.g. indexed to a position) to move one beverage pod into a brewing position and/or to remove another beverage pod out of a brewing position. For example, when the tray is in a first position, a first portion of the tray may be positioned in a brewing position in which the first portion of the tray cooperates with the brew chamber lid to brew a first beverage from a first beverage pod held within the first portion of the tray. The tray may then be moved into a second position, in which a second portion of the tray becomes positioned into the brewing position in which the second portion of the tray cooperates with the brew chamber lid to brew a second beverage from a second beverage pod held within the second portion of the tray. This process may continue until all of the available beverage pods have been brewed and/or all pod receptacles of the indexing tray are populated with spent beverage material.

In some embodiments, the indexing tray may be removable from the beverage machine to remove the spent beverage material. This may allow the user to clean the beverage machine without directly handling spent beverage material. As an illustrative embodiment, to discard the spent beverage material, a user may invert the tray to permit the spent beverage material to fall out of the pod receptacles into a desired discarding location, e.g. a composting bin or other location. The indexing tray may be washed, such as washed in a dishwasher. A cleaned indexing tray may be returned to the beverage machine and reused.

FIGS. 5A and 5B depict the indexing tray of FIG. 3 interacting with an advancing mechanism of a beverage machine according to some embodiments. The indexing tray 40 includes pod receptacles 401a and 401b (other receptacles may be present but are not visible, 401a and 401b may not be adjacent pod receptacles). In FIGS. 5A and 5B, a pod receptacle 401b is indexed into the brewing position. In some embodiments, an intermediate plate 407 between the brew chamber lid 406 and the indexing tray 40 may be help to create a sealed interface between the brew chamber lid 406 and the indexing tray 40 to form an enclosed space with the pod receptacle 401b in order to form a beverage. In other embodiments, however, no intermediate component is used, and the brew chamber lid 406 may interface directly with the indexing tray 40. For example, the brew chamber lid 406 may seal directly against a surface of the indexing tray 40.

The brew chamber lid 406 (shown open) may close on the intermediate plate 407 and seal therewith. Fluid passages 408 may provide beverage precursor fluids into the pod receptacle 401b to brew a beverage. The brew chamber lid 406 pivots about hinge 411. An upward movement of the brew chamber lid 406 upon opening the brew chamber lid depresses the pawl pivot 409 and moves the pawl pivot toward pod receptacle 401b. The advancing pawl 410 is connected to the brew chamber lid 406 at the pawl pivot 409. The advancing pawl 410 is driven toward pod receptacle 401b by the movement of the pawl pivot 409 on opening the brew chamber lid 406. The end of the advancing pawl engages with a tooth face 405 of the crown wheel 403, rotating the crown wheel (counterclockwise relative to the open brew chamber as illustrated in FIG. 5B) about central pivot axis 404.

Closing the brew chamber lid 406 causes movement of the pawl pivot 409 upward and away from pod receptacle 401b. The movement of the pawl pivot 409 on closing the brew chamber lid 406 drags the advancing pawl 410 back over the crown wheel 403. The advancing pawl 410 moving backwards over the crown wheel teeth, slides over the teeth without engaging with the faces of the teeth and hence the indexing tray does not move. As illustrated in FIGS. 5A and 5B, the advancing mechanism acts as a ratchet, moving the indexing tray 40 on opening the brew chamber lid 406 and leaving the indexing tray stationary on closing the brew chamber lid. The advancing mechanism may index the indexing tray, that is the mechanism may rotate the tray by a predetermined, fixed, and repeatable displacement (here an angular displacement).

In the illustrated embodiment, a user may open the brew chamber lid 406, thereby advancing the indexing tray by one position (e.g. angular displacement between pod receptacles) to bring a fresh pod receptacle into the brewing position. A pod receptacle possibly containing spent beverage material will be moved away from the brewing position as a fresh pod receptacle is moved into brewing position. The user may then insert a fresh beverage pod into the brew chamber, close the brew chamber lid 406 and brew a beverage.

Other embodiments of the tray advancing mechanism may work in other ways. For instance, the indexing tray may be advanced on closing the brew chamber rather than on opening the brew chamber. In one illustrative example, a user may insert a beverage pod into a beverage pod receptacle before that pod receptacle is moved into the brewing position. In some embodiments, the beverage pod may be inserted by the beverage machine. In some embodiments, an indexing tray may contain no more than one unused (e.g., fresh) beverage pod at any time. In some embodiments, unused beverage pods may be stored in the beverage machine in a location other than the indexing tray. The brew chamber lid may be controlled by the beverage machine (such as electromechanically) or through a user control such as a lever. In some embodiments, the brew chamber may not be visible to a user.

According to some embodiments, the indexing tray may be positioned by translating linearly in one or more directions. In some embodiments, the tray may have a non-circular shape, and instead may have a linear or rectangular pattern or array of pod receptacles. This disclosure is not to be limited to indexing trays that index by rotation. According to some embodiments, an indexing tray may include pod receptacles of more than one size, such as for the preparation of different beverages.

In the illustrative embodiment of FIGS. 3-4, the pod receptacles of the indexing tray have a circular shape. However, it should be appreciated that, in some embodiments, the pod receptacles of an indexing tray may have a non-circular shape. Stated another way, the pod receptacles may be of a shape having a finite order of rotational symmetry. In some embodiments, such shapes may help to restrict the number of orientations in which a user may insert a pod. In some embodiments, pod receptacle shapes may include, but are not limited to: squares, rectangles, ellipses, triangles, trapezoids, rhombuses, crescents, ellipses, pentagons, hexagons, heptagons, octagons, regular polygons, irregular polygons, serpentine shapes, or any other suitable shape having a finite order of rotational symmetry. In some embodiments, a pod receptacle may have a shape with rotational symmetry of order one, two, three, four, five, six, seven, eight, nine, ten, or any other suitable number. As an example, a shape having a rotational symmetry of order two means that the shape looks like its original orientation twice after a full 360 degree rotation. A shape having a rotational symmetry of order three means that the shape looks like its original orientation three times after a full 360 degree rotation. A shape having a rotational symmetry of order one means that the shape looks like its original orientation only once after a full 360 degree rotation.

FIG. 6 illustrates another embodiment of an indexing tray for a beverage machine. The indexing tray 60 includes a plurality of pod receptacles 601 having an elliptical shape having a rotational symmetry of order two. In some embodiments, each pod receptacle of the plurality of pod receptacles 601 may include a permeable barrier 604. The indexing tray additionally includes drive teeth 603 disposed along an outer circumference of the tray. The tray may be moved by interaction of the drive teeth 603 with a pinion or cog in the beverage machine. The drive teeth 603 may or may not be shaped as involute or cycloidal gear teeth. In some embodiments, the drive teeth may interact with a pawl, gear, pinion, cog, and/or other component in the beverage machine. While the FIG. 6 embodiment depicts pod receptacles having an elliptical shape, it should be appreciated that other pod receptacle shapes having a rotational symmetry of order two or other order may be used in other embodiments.

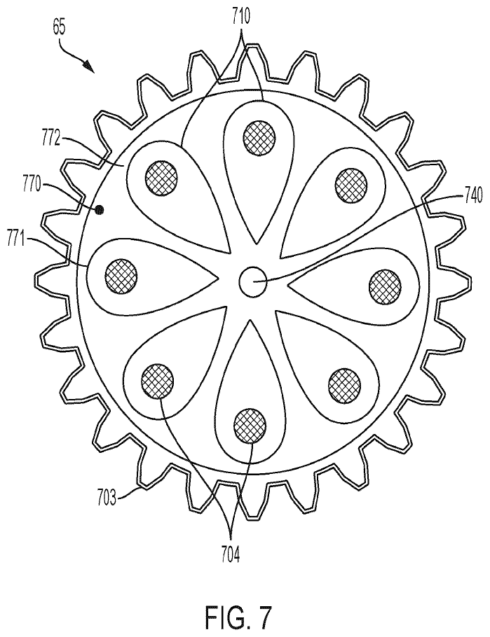

FIG. 7 illustrates another embodiment of an indexing tray according to some embodiments. The indexing tray 65 includes a plurality of pod receptacles 710 having a teardrop shape having a rotational symmetry of order one. The pod receptacles 710 may be arranged and spaced radially around a central axis, which may be a central hole 740. In some embodiments, a permeable barrier 704 may be located within each pod receptacle. Drive teeth 703 are arranged around the outer circumference of the indexing tray. The tray may be moved by interaction of the drive teeth 703 with a pawl, gear, pinion, cog, and/or other component in the beverage machine. While the FIG. 7 embodiment depicts pod receptacles having a teardrop shape, it should be appreciated that other pod receptacle shapes having a rotational symmetry of order one may be used in other embodiments.

In some embodiments, as shown in FIG. 7, an indexing tray may include start-stop marker 770. The start-stop marker 770 may serve to establish a rotational datum for the indexing tray 65 such that the indexing tray will use the start-stop marker to begin and end rotation of the indexing tray at a consistent point. For a clockwise rotating tray (as viewed from above) as in FIGS. 3, 5A, 5B, the indexing tray may be configured to begin brewing with the beverage pod located in a pod receptacle 710 one position after the start-stop marker 770 (the tray rotating clockwise relative to a stationary point), that position is labeled 771 in the figure. The indexing tray may be configured to stop brewing with the beverage pod located in a pod receptacle 710 one position before the start-stop marker 770, that position is labeled 772. If a user attempts to brew a beverage after all fresh beverage pods have been expended, the beverage machine will detect the start-stop marker 770 and prevent the indexing tray 65 from advancing further until the indexing tray is reloaded with fresh beverage pods. This may prevent the indexing tray from attempting to re-brew a spent beverage pod. The start-stop marker 770 may be a hole (as illustrated) or it may be a pin or other protruding feature. A stop or interrupter mechanism within the beverage machine may sense the start-stop marker 770, such as, for instance with a pin in the beverage machine entering the hole serving as the start stop marker 770 and triggering the disconnector mechanism which stops further motion of the indexing tray until it is reset (such as by refilling the tray). It should be appreciated that the start-stop marker could take other forms, such as a notch, a missing or filled-in gear tooth in the drive teeth 703, a missing or alternately shaped ratchet tooth in a crown wheel such as one of ratchet teeth 303 in the embodiment of FIGS. 3-4, a missing/blank pod receptacle location, an alternate pod receptacle spacing, or other feature. In some embodiments, the beverage machine may include a start-stop sensor that may be an electric, optical, or electro-mechanical sensor, such as a hall effect sensor, optical position sensor, encoder, variable reluctance sensor, magnetic switch, microswitch, break-beam sensor, camera, or any other suitable sensor. The start-stop marker may be a barcode, QR code, RFID chip or other identifier which may provide information (such as an identity of beverage pods) that is unrelated to the start-stop marker functionality. The start-stop marker 770 may be located in any suitable location on the indexing tray, including on the lower surface of the indexing tray or on its circumference or perimeter (as appropriate), or in any other location. It should be mentioned that the example described above represents only one possible embodiment. An indexing tray may rotate in either direction. The first beverage pod brewed and last beverage pod brewed may be in any location relative to the start-stop marker and may not be adjacent to the start-stop marker. A start-stop marker may be included in any embodiment of indexing tray including other embodiments disclosed herein without specific reference to a start-stop marker.

While many embodiments of the indexing tray are described with reference to the removal of spent beverage materials such as spent beverage pods (intact or broken), it should be appreciated that an indexing tray may be used with a separate spent beverage material removal system. A spent beverage material removal system may flush or wash spent beverage material from a brew chamber, such as from one of a plurality of brew chambers within an indexing tray. The brew chamber may be washed or flushed with a showerhead type sprayer. The spent beverage removal system may include a trap door or opening to transit spent beverage materials. In other embodiments, an ejector may extract spent beverage pods from a brew chamber. Intact spent beverage pods may be ejected in some embodiments. Spent beverage pods may be ejected when the brew chamber lid is opened, for instance. Ejected spent beverage pods may be directed to a spent pod collection bin, such as by a ramp, guide tube or chute. The spent pod collection bin may be removed and dumped out to remove spent beverage material from a beverage machine. In some embodiments, a spent pod collection bin may include separate chambers for liquid and solid beverage material.

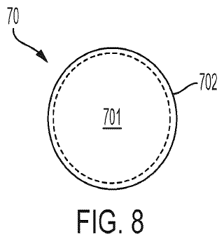

FIG. 8 illustrates a beverage pod according to some embodiments. Beverage pod 70 includes beverage ingredients 701 contained by a shell 702. The shell 702 may be a coating, such as a binder, moisture barrier, and/or air barrier applied to the beverage materials. The shell 702 may be bound to the beverage ingredients 701 at all locations along the inside surface of the shell. The beverage ingredients 701 may be bound to and inseparable from the shell 702. The beverage ingredients 701 may substantially fill the entire inside volume of the shell. In some embodiments, the shell may differ from the remainder of the beverage materials only by the degree of compaction or other processing parameter and may not include any distinct ingredient or change in composition. A beverage pod in the form of a tablet may not include a shell and may be of a uniform composition with uniform properties throughout.

A variety of beverage pod shapes are contemplated. A beverage pod may be a sphere, or a portion of sphere such as a hemisphere. A beverage pod may be a frustrum of a cone. A beverage pod may be a cylinder or prism. The beverage pod may have a first face and a second face, the first face being parallel to the second face and displaced from the second face by a distance. The first face and the second face may be of the same size and shape, for example as in a right circular cylinder, or the size and/or shape of the first face and the second face may differ. For instance, a frustrum of a cone may have two parallel faces of the same (e.g. circular) shape but having different sizes. A beverage pod may be an ellipsoid, elliptical cylinder, or teardrop shape. A beverage pod may lack any plane of symmetry in some embodiments. A beverage pod may include holes or other features.

In some embodiments, each pod receptacle of the plurality of pod receptacles is shaped to receive a beverage pod of a shape corresponding to a shape of the pod receptacle. In some embodiments, each pod receptacle is shaped to allow the beverage pod to be received into the pod receptacle in a single orientation of the beverage pod. For instance, a user may be able to insert a beverage pod into a brew chamber in a single orientation. A single allowable insertion orientation may be useful for locating an identifying code or marking in a single location such that a reader in the beverage machine may find the identifying marking in the same position and orientation to expedite reading/interpretation of the marking. Such an identifying marking may be used to identify a pod of beverage material or a brewing parameter or recipe for the same. For instance, in the indexing tray embodiment of FIG. 7-16 teardrop shaped beverage pods are used. In some embodiments, a slope or other surface contour may be applied to the bottom surface of the pod receptacle that would allow such a teardrop shaped beverage pod to fit into the pod receptacle in a single orientation of the beverage pod. Alternatively or in addition, a pin and mating hole or notch and mating bump in the perimeter of the teardrop shaped pod (or any other location of the pod) and pod receptacle respectively could allow such a beverage pod to be inserted only in a single orientation of the beverage pod.

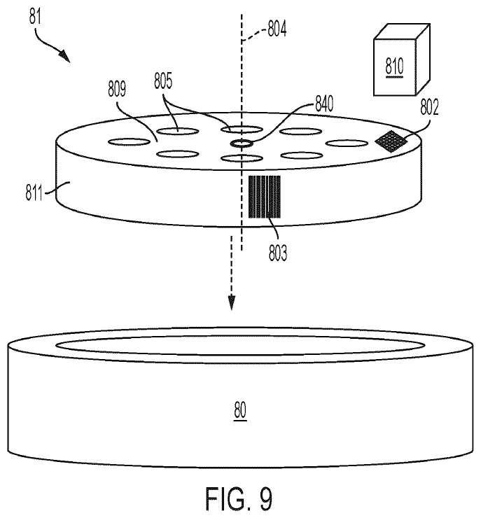

According to another aspect, in some embodiments, an indexing tray may receive a cassette of beverage pods. In some embodiments, the cassette may be disposable and the indexing tray may be re-useable. FIG. 9 depicts an embodiment of an indexing tray and cassette of beverage pods. In embodiment shown, the indexing tray 80 is configured to receive a cassette 81 of beverage pods. The cassette of beverage pods may include a plurality of pod receptacles 805. A corresponding plurality of beverage pods may reside within the pod receptacles. The indexing tray 80 is configured to removably receive and support the cassette 81 of beverage pods. The cassette 81 of beverage pods may be removably inserted into the indexing tray by a user. The cassette 81 of beverage pods may additionally include one or more identifiers, such as identifying marks such as a bar code 803, or a QR code 802, or other identifying mark. Other identifiers may include RFID chips or other suitable identifiers on or within the cassette. The identifier may be read by a reader 810. The reader 810 is part of the beverage machine and may be a barcode reader, QR reader, RFID reader, camera, etc., as appropriate. The identifier may include information such as the identity of the beverage pods contained within the cassette, brewing parameters for the beverage pods contained within the cassette, lot information, expiration, and/or other information. Although both the bar code 803 and QR code 802 are illustrated on the same cassette 81, any number of identifiers may be used including a single identifier. Likewise, the placement of the identifiers in FIG. 8 are for illustrative purposes only and may not represent the actual placement of identifiers which may be located at any convenient location on the cassette 81.

In some embodiments, beverage pods may be contained loosely within the pod receptacles 805 within the cassette 81, or beverage pods may be rigidly affixed to the pod receptacles (e.g. via an interference fit, or an interlock such as one or more protrusions in the cassette extending at least partially through corresponding void(s) in the pod or vice versa, or other arrangement). In some embodiments, beverage pods may have the same size and shape as the pod receptacles, or may be slightly larger to achieve an interference fit. The pod receptacles 805 may be covered by a film or coating. The beverage pod may extend up to a surface of the cassette. The pod receptacles 805 may cooperate with a brew chamber lid to form a beverage. Beverage pods may be brewed directly in the cassette 81 of beverage pods. Spent beverage material may remain within the cassette 81 of beverage pods. When all of the fresh beverage pods of the cassette of beverage ingredients are expended, the user may remove the cassette of beverage material from the indexing tray and discard the cassette and replace a fresh cassette of beverage materials in the beverage machine.

The cassette of beverage pods may include a plurality of beverage pods disposed in a plurality of pod receptacles spaced in the cassette. In some embodiments, the plurality of pod receptacles may be disposed radially about a central pivot axis 804 of the cassette and separated from each other by an angular displacement. In some embodiments, the pod receptacles may be spaced in another way, such as in a linear or rectangular pattern. The cassette may rotate relative to the beverage machine about the central pivot axis 804.

The plurality of pod receptacles may be supported by a cassette housing 811. The cassette housing may interface with the beverage machine. The cassette may include partitions 809 separating the pod receptacles 805. In some embodiments, the cassette may have a central hole 804 which may be a through-hole or a blind hole. The cassette housing may be made from a recyclable and/or biodegradable material. The cassette may be made of cardboard, cellulose, paper, metallic foil, plastic including recyclable plastics, glass, or other suitable material separately or in combination. Cassettes may be cleaned and reused in some cases.

Beverage pods may be loaded into the cassette at the factory. Beverage pods may be sealed in the cassette and covered by a frangible cover such as a film or foil which may maintain freshness. The frangible cover may sealingly enclose a beverage pod within a pod receptacle. The beverage pods may be sealed in a controlled/inert atmosphere such as an enhanced nitrogen atmosphere, pure nitrogen, argon, other inert gas atmosphere, partial vacuum, etc. The controlled atmosphere may be a reduced oxygen atmosphere, the reduced oxygen atmosphere may contain a lower concentration of oxygen than air. The beverage machine may break (e.g. pierce, puncture, rupture, cut, peel back, etc.) the frangible cover to access the beverage pods.

In some embodiments, pods may be brewed directly within the cassette. In other embodiments, beverage pods may be removed from the cassette and relocated to a separate brew chamber for brewing.

An identity, position, etc. of the beverage pods loaded in the cassette may be included in an identifier such as a bar code, QR code, other pattern, RFID chip, or other identifier. The beverage machine may scan the identifier to determine brewing parameters for the pods contained within the cassette. Each beverage pod may have one or more associated brewing parameters. In some cases, the identifier may store at least as many brewing parameters as the cassette has beverage pods. All brewing parameters may be the same in some cases, such as if the cassette contains only a single type of beverage pod. The cassette may be received by the beverage machine. An empty cassette may be removed from the beverage machine and replaced by a fresh cassette. Cassettes may be disposable in some embodiments.

A cassette of beverage pods may include a start-stop marker as discussed in FIG. 7. The start-stop marker may be mechanical, such as a pin, protrusion, notch, hole etc. or electrically or optically sensed. In some embodiments, the identifier on the cassette, such as bar code 803, QR code 802 or an RFID chip may serve as the start-stop marker (separate from or in addition to other functions of the identifier). In embodiments where the cassette includes a frangible cover sealing the plurality of pod receptacles, a broken/ruptured/removed frangible cover may serve as the stop marker. Such an embodiment may not include a start marker as any beverage pod still sealed within the cassette can be identified as fresh (e.g., not yet brewed). A separate pattern or code (such as a barcode etc) may be included on the frangible cover to assist the beverage machine in determining is the frangible cover is intact. Punch marks or other marks created when a frangible cover is pierced may additionally serve to identify locations where the beverage pod is spent (or absent). According to some embodiments, a beverage machine may count the number of brews of a specific cassette to identify the number and/or location of remaining fresh beverage pods. The beverage machine may store this information in memory, such that a partially used cassette may be removed and reinstalled at a later time and the beverage machine will remember the number and/or position of remaining fresh beverage pods. According to some embodiments, a beverage machine may scan a cassette, such as by moving to all possible beverage pod positions to take an inventory of the beverage pods in the cassette. The beverage machine may take inventory at regular intervals (such as once a day), upon some action occurring (such as brewing a beverage, recovery of electrical power to the beverage machine, etc.) and/or when a cassette is inserted into the beverage machine (e.g. a fresh cassette, a partially used cassette or a used cassette). The inventory may be stored in memory and may additionally be accessible to a user.

The indexing tray may be made from any suitable material including polymers, metals, glass, or ceramic. The indexing tray may be manufactured by molding, such as injection molding, stamping, casting, welding, or any other suitable processes. Some portions of the indexing tray, such as the drive mechanism (e.g., crown wheel, gear teeth, etc) and/or the permeable marrier may be made as separate pieces and may be of a different material from the rest of the indexing tray.

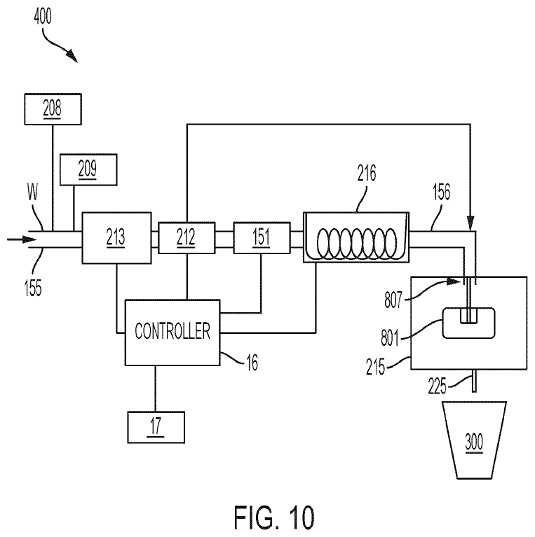

FIG. 10 shows a schematic block diagram of various components that may be included in a beverage machine 400 in one illustrative embodiment. Those of skill in the art will appreciate that a beverage machine 400 may be configured in a variety of different ways, and thus aspects of the invention should not be narrowly interpreted as relating only to one type of beverage machine. In this embodiment, a precursor liquid (e.g. hot or cold water) may be supplied from a liquid supply (e.g. a water reservoir) to a brew chamber 215. A beverage pod 801 comprising one or more beverage ingredients (e.g. coffee grounds, soluble coffee, tea leaves, etc.) may be included for use in forming the beverage. The beverage pod 801 may comprise a compacted beverage tablet in which its beverage ingredients 211 have been compacted into a tablet form.

A liquid supply W may supply beverage precursor liquid to a brew chamber 215. The source W may have any suitable arrangement, e.g., may provide liquid from a removable or fixed storage tank, a mains water supply or other source. Thus, in some cases, the liquid provided from the source W may vary in temperature by a wide degree depending on various factors, such as time of year, a temperature of a room in which the beverage machine 400 is located, etc. For example, if the source W is a reservoir that is filled by a user, the temperature of liquid in the reservoir may vary between room temperature (e.g., if liquid sits in the reservoir for an extended time) and a cooler temperature (e.g., if the reservoir has just been filled with water that is dispensed from a tap).

A pump 210 may drive liquid from the liquid supply W through a valve 151 through a liquid conditioner 216 (e.g. a heater, chiller, and/or carbonator), into a supply line 156 through a fluid port 807 and into the brew chamber 215 where a beverage pod 801 is held.

Following introduction of beverage precursor liquid into the brew chamber 215, the beverage pod 801 may be mixed with the precursor liquid to form a desired beverage. The beverage may then be dispensed to a container 300 (e.g., a cup or a carafe) using a beverage machine dispenser outlet 225.

The pump 210 and/or valve 151 may be in electrical communication with a controller 16 and/or a user interface. In some embodiments, the pump 210 may serve as the sole fluid driving source that moves liquid from the liquid supply W to the brew chamber 215.

In some embodiments, an air valve 208 may be provided between the liquid supply W and the pump 210. The air valve 208 may allow air trapped within the liquid line 155 to escape the flow path prior to entering the pump 210. This may contribute to more efficient operation of the pump 210 and any downstream components, or reduce a likelihood of damage to the pump 210 or any downstream components. The air valve 208 may be in electrical communication with the controller 16 and/or a user interface.

In some embodiments, a pressure relief valve 212 may be provided between the pump 210 and the valve 151. The pressure relief valve 212 may allow liquid from the pump 210 to bypass the valve 151 in the event that excess pressure builds between the pump 210 and the valve 151. Liquid from the pressure relief valve 212 may be allowed to exit the beverage machine 400 through the brew chamber 215, or any other appropriate outlet of the machine. In this way, the pressure relief valve 212 may prevent a build-up of excess pressure between the pump 210 and the valve 151. This configuration may prevent damage to the pump 210, the valve 151, and/or other system components, particularly in the event that the valve 151 or another downstream component becomes blocked or clogged.

In some embodiments, a liquid level detector 209 may be provided in the beverage machine 400 near the liquid supply W, or in some embodiments, in the liquid supply W itself. In some embodiments, the liquid level detector may be a conductivity probe positioned near an outlet of the liquid supply W. The liquid level detector may sense when the liquid in the liquid supply W is below a threshold fill level, such as when the liquid supply is empty or nearly empty. In other embodiments, the liquid level detector may include a microswitch with an attached float that rises with liquid level in a tank of the liquid supply W. In another embodiment, the liquid level detector may detect a capacitance change associated with one or more liquid levels in the tank, may use an optical emitter/sensor arrangement (such as an LED and photodiode) to detect a change in liquid level, may use a pressure sensor, may use a floating magnet and Hall effect sensor to detect a level change, and others. Thus, the liquid level detector is not necessarily limited to a conductive probe configuration. Moreover, the liquid level detector may include two or more different types of sensors to detect different levels in a tank of a liquid supply. For example, a pressure sensor may be used to detect liquid at a first dispense level, while a conductive probe may be used to detect liquid at a second, different dispense level. The liquid level detector 209 may be in electrical communication with the controller 16 and/or a user interface.

In some embodiments, the liquid conditioner 216 is a heater comprising any appropriate type of heater, boiler, or heat exchanger. For example, in some embodiments, the liquid conditioner 216 may be a flow-through heater that has a relatively small volume, e.g., a tube with associated heating element to heat liquid in the tube. Examples of flow-through heaters include a flat flow through heater, a spiral flow through heater, a U-shaped flow through heater, or any other type of heater. In some embodiments, the heater may be a heating element that heats a hot water tank. The heater may be in thermal communication with the hot water tank, e.g. inside the hot water tank in direct contact with the water inside the tank, or in a non-water contact arrangement in which the heater is provided outside the tank or embedded within the tank wall. The liquid conditioner 216 may be in electrical communication with the controller 16 and/or a user interface.

Of course, heating of the liquid is not necessary, and instead (or additionally) the liquid conditioner may comprise a chiller to cool the liquid, a carbonator to carbonate the liquid, or otherwise condition the liquid in a way that alters the volume of liquid supplied to the brew chamber.

The controller 16 may include a programmed processor and/or other data processing device along with suitable software or other operating instructions, one or more memories (including non-transient storage media that may store software and/or other operating instructions), temperature and liquid level sensors, pressure sensors, input/output interfaces (such as a user interface 17), communication buses or other links, a display, switches, relays, triacs, or other components necessary to perform desired input/output or other functions. A user interface 17 may be included to provide information to a user and/or receive information from a user, such as buttons, a touch screen, a voice command module (including a microphone to receive audio information from a user and suitable software to interpret the audio information as a voice command), a visual display, one or more indicator lights, a speaker, and so on.

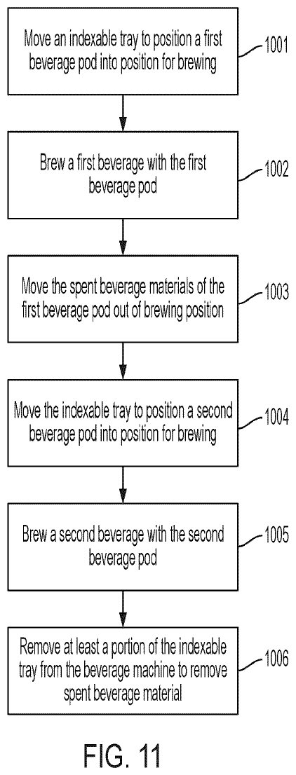

FIG. 11 illustrates a diagram for a method to form a beverage. The method to form the beverage includes: moving an indexing tray to position a first beverage pod into position for brewing 1001; brewing a first beverage with the first beverage pod 1002; moving the spent beverage materials of the first beverage pod out of the brewing position 1003; moving the indexing tray to position a second beverage pod into position for brewing 1004; brewing a second beverage with the second beverage pod 1005; and removing at least a portion of the indexing tray from the beverage machine to remove spent beverage material 1006. In some embodiments, the method may include inserting a plurality of beverage pods into the beverage machine before brewing the first beverage. In other embodiments, the method may include inserting a fresh beverage pod before brewing a beverage. Inserting a fresh beverage pod may include inserting a fresh beverage pod directly into the brew chamber. In some embodiments the indexing tray may include n pod receptacles where n is an integer greater than 2. Removing at least a portion of the indexing tray from the beverage machine to remove spent beverage material may include removing at least a portion of the indexing tray from the beverage machine to remove spent beverage material after brewing n beverages.

According to some embodiments, the method for forming a beverage may additionally include inserting a plurality of beverage pods into a beverage machine by inserting a cassette of beverage ingredients including a plurality of beverage pods into the beverage machine and removing a portion of the indexing tray from the beverage machine to remove spent beverage material by removing the cassette of beverage material from the beverage machine. The spent beverage machine may be reloaded by inserting another cassette of beverage ingredients into the beverage machine. The method may include reading an identifier on the cassette after inserting the cassette of beverage ingredients into the beverage machine and identify a brewing parameter for a beverage pod within the cassette of beverage ingredients based on information from the identifier. The beverage machine may automatically read the identifier and identify a brewing parameter without user input.

Although aspects of the present disclosure may be described with respect to single serving beverage machines, this disclosure is not meant to be limiting to single serving beverage machines or to the preparation of any quantity of beverage and may be applied to any beverage machine which may prepare any quantity of beverage or any number of beverage servings during a beverage forming operation.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present disclosure as discussed above. Additionally, it should be appreciated that according to one aspect of this embodiment, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present disclosure may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A beverage machine, comprising:
a brew chamber lid; and
a tray comprising a first portion and a second portion, the tray being moveable relative to the brew chamber lid;
wherein the tray is moveable to position the first portion of the tray into a brewing position to cooperate with the brew chamber lid to brew a first beverage from a first beverage pod and wherein the tray is moveable to position a second portion of the tray into the brewing position to cooperate with the brew chamber lid to brew a second beverage from a second beverage pod.

2. The beverage machine of claim 1, wherein the tray includes a plurality of pod receptacles, and wherein the first portion of the tray corresponds to a first pod receptacle of the plurality of pod receptacles, and the second portion of the tray corresponds to a second pod receptacle of the plurality of pod receptacles.

3. The beverage machine of claim 1, wherein the tray is further configured to be removable from the beverage machine to remove spent beverage pods from the beverage machine.

4. The beverage machine of claim 1, wherein the tray includes a central pivot axis and the tray is configured to rotate relative to the brew chamber lid about the central pivot axis.

5. The beverage machine of claim 4, wherein the tray includes a plurality of pod receptacles, and wherein the first portion of the tray corresponds to a first pod receptacle of the plurality of pod receptacles, and the second portion of the tray corresponds to a second pod receptacle of the plurality of pod receptacles, and
wherein the plurality of pod receptacles are positioned radially about the central pivot axis and are spaced from each other by an angular displacement.

6. The beverage machine of claim 2, wherein each pod receptacle of the plurality of pod receptacles includes a permeable barrier disposed in the pod receptacle, the permeable barrier being configured to allow passage of brewed beverage and restrict passage of solid beverage ingredients.

7. The beverage machine of claim 6, wherein the permeable barrier comprises a plurality of holes configured to allow passage of brewed beverage and to restrict passage of solid beverage ingredients.

8. The beverage machine of claim 6, wherein the permeable barrier comprises a mesh screen.

9. The beverage machine of claim 6, wherein the permeable barrier comprises a plurality of tubes configured to allow passage of brewed beverage and to restrict passage of solid beverage ingredients.

10. The beverage machine of claim 9, wherein one or more tubes of the plurality of tubes are configured to extend into one or more of the plurality of pod receptacles.

11. The beverage machine of claim 2, wherein each pod receptacle of the plurality of pod receptacles is configured to receive a beverage pod of a shape corresponding to a shape of pod receptacle, and wherein each pod receptacle is further configured to allow the beverage pod to be received into the pod receptacle in a single orientation of the beverage pod.

12. The beverage machine of claim 11, wherein each pod receptacle has a finite order of rotational symmetry.

13. The beverage machine of claim 11, wherein each pod receptacle has an order of rotational symmetry of one.

14. The beverage machine of claim 1, wherein the tray is configured to removably receive and support a cassette of beverage pods, the cassette including a plurality of pod receptacles each containing a beverage pod.

15. The beverage machine of claim 14, further comprising the cassette of beverage pods.

16. The beverage machine of claim 5, further comprising a pawl, wherein the tray includes a plurality of teeth configured to move the tray an angular displacement by interaction with the pawl on at least one of the plurality of teeth.

17. The beverage machine of claim 5, further comprising a pinion, wherein the tray includes a plurality of gear teeth configured to move the tray an angular displacement by interaction with the pinion.

18. The beverage machine of claim 5, further comprising an electric motor, wherein the tray is moved by the electric motor.

19. The beverage machine of claim 1, wherein the tray is movable along a linear path to position the first portion of the tray into the brewing position and to position the second portion of the tray into the brewing position.

20. The beverage machine of claim 1, wherein the tray is in a first position when the first portion is in the brewing position and wherein the tray is in a second position when the second portion is in the brewing position; and
wherein the tray is configured to move from the first position to the second position as the brew chamber lid is opening.

21. The beverage machine of claim 1, wherein the tray is in a first position when the first portion is in the brewing position and wherein the tray is in a second position when the second portion is in the brewing position; and
wherein the tray is configured to move from the first position to the second position as the brew chamber lid is closing.

22-28. (canceled)

29. A method of forming a beverage comprising:
moving a tray to position a first beverage pod into position for brewing;
brewing a first beverage with the first beverage pod;
moving the tray to position a second beverage pod into position for brewing and to move spent beverage material of the first beverage pod out of position for brewing.

30-38. (canceled)

39. A cassette of beverage pods comprising:
a cassette housing configured to be removably received within a beverage machine; and
a plurality of pod receptacles each containing at least one beverage pod.

40-46. (canceled)
